(19) United States
(12) Patent Application Publication
(10) Pub. No.: US 2007/0130473 A1
(43) Pub. Date: Jun. 7, 2007

(54) System and method for access control

(76) Inventor: James Steven Mazotas, Grove City, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/633,779

(22) Filed: Dec. 4, 2006

Related U.S. Application Data
(60) Provisional application No. 60/741,707, filed on Dec. 2, 2005.

(51) Int. Cl. H04L 9/00

(52) U.S. Cl. 713/183

(57) ABSTRACT

A system and method for authenticating a user based on multiple factors is provided. The system and method also control access by the user and monitor the user's activity.

### RELATED APPLICATION

The present application is being filed as a non-provisional patent application claiming benefit under 35 U.S.C. § 119(e) from U.S. Provisional Patent Application No. 60/741,707 filed on Dec. 2, 2005, the disclosure of which is incorporated by reference in its entirety.

### FIELD

The invention relates generally to access control and, more particularly, to a system and method for authenticating a user, controlling access by the user and monitoring the user's activity.

### BACKGROUND

In today's competitive business environment, computers and the Internet have become inseparable tools for increasing productivity. Employers depend on software programs for most, if not all, of their employee's job tasks. They also rely heavily on the Internet to communicate and share information between customers, vendors and themselves.

But there are trade-offs. The same activities that have increased worker efficiency (e.g., running applications, sharing files and communicating from remote locations) have also made computers and Internet connections increasingly susceptible to all kinds of malicious attacks that prey on inherently poor security protocols, applications and solutions.

Furthermore, entities such as contractors, partners and agencies often play an important role in an organization. As a result, a company may need to grant access to its technology assets (e.g., network resources) and proprietary information (e.g., customer names) to these entities, which poses a significant risk.

Employees and business partners already granted access privileges also pose significant risks. It could be a terminated employee that wants to alter his or her employment record. It could also be an outside contractor, who has a side business selling proprietary information to the competition. It could even be an active employee who unwittingly posts confidential information in a blog or on a message board.

Because of these risks, employers are recognizing that their security activities must evolve from that of managing technology assets (i.e., a passive approach) to managing the people who use those assets (i.e., an active approach).

A conventional active approach is the use of two-factor authentication (TFA) as an authentication protocol. The two factors are something a user knows (e.g., a password) and something they have (e.g., a token). The token can be a smart card, a mobile phone or some other physical device that synchronizes with a remote server to prove the user's identity. The goal of TFA is to provide greater security by mitigating the risks associated with traditional passwords by additionally requiring the token to gain access to assets or information.

TFA, however, suffers from many drawbacks. For example, TFA often requires different software to drive individual functions (e.g., web access, network login, system interfacing) and customizing for different client devices (e.g., PCs, Macs, PDAs, etc.), which significantly complicates installation and compatibility across users. In TFA, different applications may require different logins, such that the user is required to memorize multiple passwords or PIN codes.

Because there are various implementations of TFA (i.e., it is not standardized), interoperability issues arise. Additionally, most TFA systems are proprietary and charge an annual fee per user. If the tokens used in TFA are damaged or lost, the replacement cost of the tokens can be significant.

Another problem with many TFA systems is that passwords are stored in the token, a client machine or on a server. This presents a security issue (i.e., potentially negates one factor of the TFA) since an intruder could readily find the password used for authentication. Yet another concern with TFA is the software stored on the client machine (e.g., the user's computer). The token may store the user's credentials securely, but the potential for breaking the system is then shifted to the software interface between the hardware token and the operating system on the user's computer, potentially rendering the added security of the TFA system useless.

Furthermore, the focus of TFA systems is the authentication of a user. Consequently, TFA systems often lack additional security tools and, thus, do not provide features such as dynamically limiting the user's authorized activities and tracking the user's actual activities.

Consequently, there is a need in the art for a system and method that provides improved authentication for verifying the identify of a user, while also providing access control and monitoring with respect to the user's activities.

### SUMMARY

In view of the above, it is an exemplary aspect to provide a system and a method for authenticating a user based on multiple factors (i.e., three or more disparate components).

It is another exemplary aspect to provide a system for authenticating a user that requires a physical token associated with the user to be connected with a particular device associated with the user.

It is another exemplary aspect to provide a unified system for isolating, managing and logging a user's identity, usage and compliancy during a session. The system is readily scalable and can be easily integrated into existing security platforms.

### BRIEF DESCRIPTION OF THE DRAWINGS

The above aspects and additional aspects, features and advantages will become readily apparent by describing in detail exemplary embodiments thereof with reference to the attached drawings, wherein like reference numerals denote like elements, and:

FIG. 1 is a diagram of a system for authenticating a user based on a physical token associated with the user being connected to a particular device associated with the user, according to an exemplary embodiment.

FIG. 2 is a diagram of the memory stick being used as an exemplary token in the exemplary system of FIG. 1.

FIG. 3 is a flowchart illustrating a method of authenticating a user based on a physical token associated with the user being connected to a particular device associated with the user, according to an exemplary embodiment.

### DETAILED DESCRIPTION

While the general inventive concept is susceptible of embodiment in many different forms, there are shown in the drawings and will be described herein in detail specific embodiments thereof with the understanding that the present disclosure is to be considered as an exemplification of the principles of the general inventive concept. Accordingly, the general inventive concept is not intended to be limited to the specific embodiments illustrated herein.

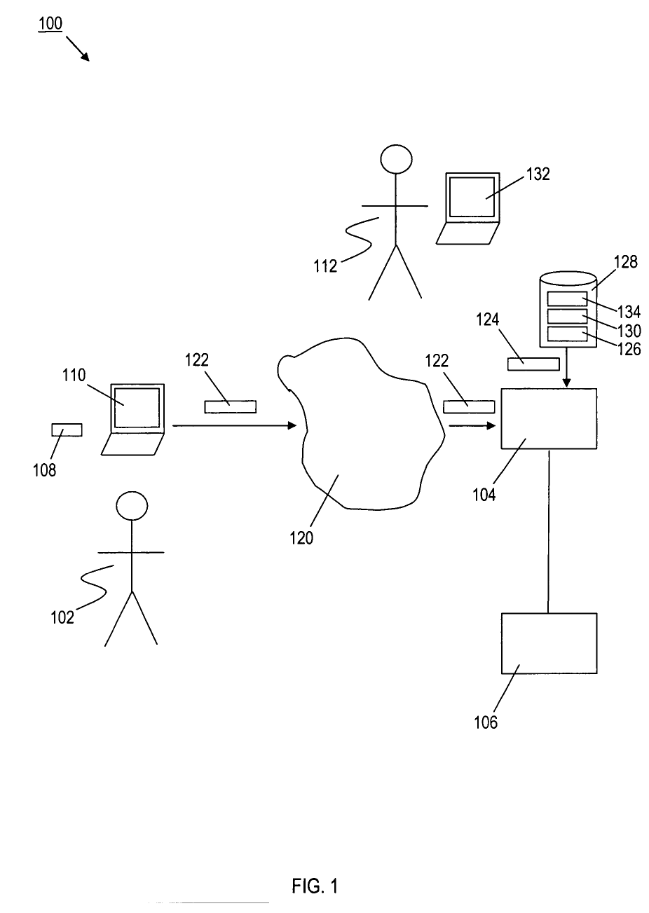

An exemplary system 100 for authenticating a user 102 based on multiple factors (i.e., three or more disparate components) is shown in FIG. 1. The system 100 includes a server 104 (or multiple servers) that performs authentication of the user 102 requesting access to assets (e.g., applications) and/or data belonging to an organization (e.g., a company), wherein the assets and data are generically represented in FIG. 1 as resources 106. In one exemplary embodiment, a server 104 is located on each local area network (LAN) of the company. Through the multi-factor authentication (MFA), the server 104 insures that the resources 106 belonging to the company can only be accessed by authorized individuals using their authorized devices.

According to the MFA, the user 102 must connect a token 108 associated with the user 102 to a device 110 that is also associated with the user 102. Each token 108 will be associated with only one user 102, although multiple devices can be associated with a user. An administrator 112 will have previously associated the token 108 and the device 110 with the user 102. The device 110 can be a computer, a personal digital assistant (PDA), or any other processing device having input and output (I/O) support. The token 108 can be connected to the device 110 directly or can interface with the device 110 over a wired (e.g., IEEE 1394/firewire cable) or wireless (e.g., Bluetooth) connection. In one exemplary embodiment, the token 108 is a universal serial bus (USB) flash memory stick (memory stick) and the device 110 is a laptop computer.

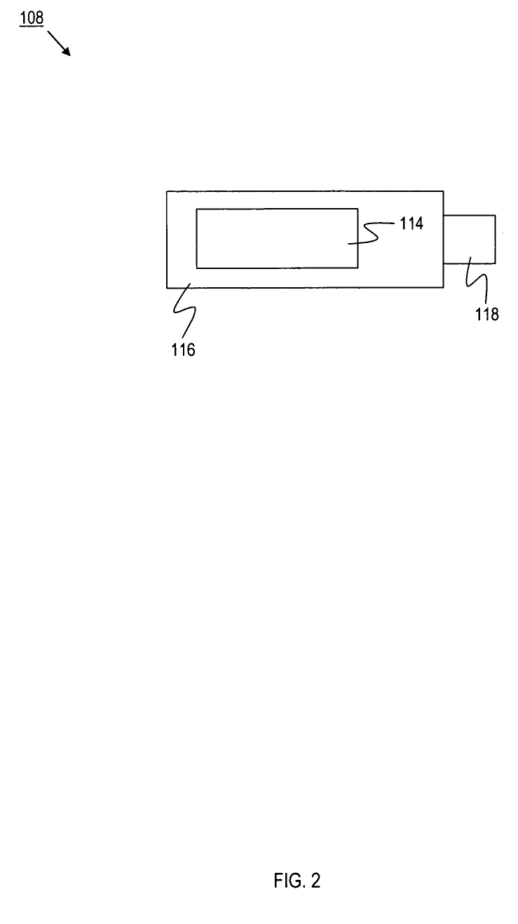

As shown in FIG. 2, the memory stick 108 can be a standard, off-the-shelf, memory stick. As such, the memory stick 108 includes a memory 114 (e.g., flash memory) disposed in a housing 116 and a connector 118 extending from the housing 116. The memory stick 108 is provided with a serial number (e.g., stored in the memory 114) that is unique among all other tokens. The serial number can, for example, resemble the form of a media access control (MAC) address. The memory stick 108 is also provided with any additional data needed to assist in the MFA or other functions of the system 100. For example, instructions for finding a network 120 (e.g., the Internet, a LAN) and then navigating to a particular address (e.g., that of the server 104) via the network 120 can be stored in the memory 114 of the memory stick 108. The data stored in the memory 114 of the memory stick 108 is not altered during the MFA. In one exemplary embodiment, the memory stick 108 is locked after its preparation for use in the system 100, such that the data stored in its memory 114 cannot be modified. Since the memory 114 of the memory stick 108 is not used for data storage during the MFA, the size of the memory 114 can be kept relatively small which allows the cost associated with the memory stick 108 to be low. Furthermore, given its relatively small size, the memory stick 108 is easy for the user 102 to carry and protect (e.g., conceal), which are characteristics of a good token.

Once the memory stick 108 is inserted into a USB port of the laptop computer 110, establishment of a session is initiated. For example, standard 128-bit secure sockets layer (SSL) web services can be used to establish a public key infrastructure (PKI), RSA-encrypted session between the laptop computer 110 and the server 104, wherein the laptop computer 110 sends its public PKI key to the server 104 and the server 104 responds by sending its public PKI key to the laptop computer 110. Each of these keys is generated, for example, at 4096-bit cipher key length. The keys are unique for each session. It will be appreciated that other forms of a secure session could be used instead.

The session allows for secure communication between the laptop computer 110 and the server 104. In one exemplary embodiment, the memory stick 108 must remain connected to the laptop computer 110 during the entire session or else the session is terminated.

In one exemplary embodiment, software (e.g., one or more modules 134 as described below) is sent from the server 104 to run in the memory of the laptop computer 110 during the session. In this manner, the system 100 does not require any software be installed or stored on the laptop computer 110. Accordingly, because the software routines reside only temporarily in the memory of the laptop computer 110 and only as needed during the session, it is unlikely that a malicious user would be able to exploit the software routines.

The software routines running in the memory of the laptop computer 110 will determine various unique and static attributes of the laptop computer 110 and use one or more of these attributes to create a unique device imprint (UDI). For example, the central processing unit (CPU) signature, the hard drive signature, the network interface signature, the operating system (OS) serial key signature, the OS installation signature, etc. could be used to form the UDI. In one exemplary embodiment, at least 20 unique attributes of the laptop computer 110 are used to form the UDI. Each and every device (e.g., the laptop computer 110) requiring access to the resources 106 will be associated with its own unique UDI.

In one exemplary embodiment, the UDI and the serial number of the memory stick 108 are used to create a series of unique asymmetrical encryption keys that are hashed with an algorithm (e.g., SHA1, MD5) to generate an encrypted profile that uniquely associates the laptop computer 110 to the user 102.

Thereafter, the MFA of the user 102 commences. During the MFA, the system 100 will attempt to verify three or more distinct factors. In one exemplary embodiment, the serial number of the memory stick 108 and the UDI of the laptop computer 110 are encrypted and transmitted to the server 104, as two components of login data 122. Furthermore, the user 102 is required to directly input information, such as a password, associated with the user 102. For example, the user 102 can input the password into a dialog box displayed on a screen of the laptop computer 110. The password is then encrypted and transmitted to the server 104, as a third component of the login data 122. Additional information, such as a user name, can be required from the user 102 as well.

The server 104 receives and decrypts the serial number of the memory stick 108, the UDI of the laptop computer 110 and the password of the user 102, as the login data 122. The server then verifies whether each of the serial number, the UDI and the password of the login data 122 corresponds to authentication data 124 for the user 102 that was previously stored when a user profile 126 of the user 102 was registered with the server 104. By way of example, the user profile 126 can be created and registered with the server 104 by the administrator 112. The user profile 126 can be stored in a database 128 installed on or in communication with the server 104. The authentication data 124 of the user profile 126 includes the serial number of the memory stick 108 associated with the user 102, the UDI of the laptop computer 110 (and any other authorized devices) associated with the user 102 and the password of the user 102.

If the server 104 determines that any of the serial number, the UDI and the password of the login data 122, as received by the server 104 over the network 120, fails to correspond to the authentication data 124 stored in the database 128, the user 102 is denied access to the resources 106. The administrator 112 is then notified that the user 102 attempted to gain access to the resources 106 but could not be authenticated. For example, an e-mail, text message or the like could be sent to the administrator 112 to provide the notification. Additionally, the server 104 can update a log 130 stored in its database 128 to reflect the failed attempt by the user 102 to gain access.

In one exemplary embodiment, if the user 102 is denied access, the user 102 is required to enter a predetermined personal identification number (PIN) to request access to the resources 106. The PIN entered by the user 102 is then encrypted and transmitted to the server 104 over the network 120. If the server 104 verifies that the received PIN is correct, the administrator 112 is notified that the user 102 is requesting access to the resources 106. The administrator 112 can then decide whether or not to instruct the server 104 to grant the user 102 access to the resources 106. Thus, the PIN provides a mechanism for the user 102 to request emergency validation when the system 100 will not grant the user 102 access to the resources 106. Of course, the PIN is just an example and other criteria could be used in an effort to insure that the user 102 requesting access is not an impostor.

In one exemplary embodiment, the user 102 is always denied access to the resources 106 if the memory stick 108 is not connected to the laptop computer 110.

In one exemplary embodiment, the administrator 112 can define thresholds on how closely the login data 122 must match the authentication data 124 before the user 102 will be authenticated by the server 104. For example, if a sufficient number of the attributes used to generate the UDI in the login data 122 match the corresponding attributes used to generate the UDI in the authentication data 124, the user 102 is authenticated. In one exemplary embodiment 85% (e.g., 17 out of 20) of the attributes must match before the server 104 will authenticate the user 102.

If the server 104 verifies that each of the serial number, the UDI and the password received by the server 104 over the network 120 matches (or falls within the predefined thresholds of) the authentication data 124 for the user 102 that was previously stored in the database 128, the user 102 is authenticated. Once authenticated, the user 102 can be granted access to the resources 106. Upon successful authentication of the user 102, a notification is sent (e.g., via e-mail, text message, phone message) to the administrator 112 documenting the date and time that the user 102 was authenticated. Additionally, the date and time that the user 102 was authenticated can be recorded in the log 130.

Thus, the MFA provides a high level of assurance that the user 102 requesting access to the resources 106 is who he or she purports to be, i.e., an authorized user. In particular, the system 100 requires that the user 102 (1) have something (tangible), i.e., the memory stick 108; (2) know something (intangible), i.e., the password; and (3) attempt access from an authorized device, i.e., the laptop computer 110, for the server 104 to authenticate the user 102. In addition to functioning as a stand-alone authentication protocol or approach, the MFA can be integrated into a company's existing authentication framework. For example, the MFA can be used to enhance the security of an OS-based login prompt, virtual private networks (VPNs), etc.

If the system 100 successfully authenticates the user 102, the server 104 performs access control by determining the appropriate access to the resources 106 to grant the user 102. For example, the server 104 determines which applications, networks, systems, data and the like that the user 102 is allowed to access. In one exemplary embodiment, the access level of the user 102 is defined in the user profile 126 of the user 102 that is stored in the database 128. For example, the user profile 126 can define which of the resources 106 the user 102 is allowed to access. Conversely, the user profile 126 can define which of the resources 106 the user 102 is prohibited from accessing. Thus, in addition to determining whether the user 102 is who he or she purports to be (i.e., a user authorized to access the resources 106), the system 100 also determines what restrictions, if any, should be placed on the user 102. Once the server 104 determines the appropriate level of access for the user 102, the user 102 can access the resources 106 according to the access control imposed by the server 104.

During the session, if the user 102 accesses a resource 106 that he or she is authorized to use, the resource 106 is passed through the server 104 to the user 102. In one exemplary embodiment, the resources 106 being passed through the server 104 to the user 102 are stored only temporarily in a memory of the server 104. The user 102 (using the laptop computer 110) is not able to directly access the resources 106 without going through the server 104.

In one exemplary embodiment, all data that the user 102 receives and/or is able to view by accessing the resources 106 is stored only in the memory of the laptop computer 110. In particular, the user 102 is prevented from storing this data (e.g., on a hard drive, compact disk (CD), network port) unless expressly authorized to do so by the system 100. Accordingly, because the data resides only in the memory of the laptop computer 110 and only as needed during the session, it is unlikely that the data will be misappropriated.

After the server 104 has authenticated the user 102 and determined the appropriate level of access control for the user 102, the server 104 begins monitoring and logging the activities of the user 102 for the duration of the session. In one exemplary embodiment, the system monitors and logs all activity of the user 102, as well as other noteworthy events. These activities and events can be stored in the log 130 (or other logs) or some other data store for later retrieval and analysis. Accordingly, if the system 100 is ever compromised, it is a simple matter to identify every user (e.g., the user 102) who was in contact with the system 100 at that time and could have been responsible. Thus, by reviewing the log 130 to determine the activities of these users, the culprit is readily identifiable.

The system 100 supports real-time monitoring and logging, which facilitates notifying the administrator 112 of any suspicious or inappropriate behavior by the user 102 so that it can be handled in a timely manner. In this manner, the administrator 112 is kept abreast of the status of the system 100 regardless of his or her physical location or the time and date. For example, if the administrator 112 is at a movie theater on a Sunday evening, he or she would still receive a notification (e.g., a text message sent to his or her cell phone) indicating that an unauthorized user is attempting to access the system 100. Thereafter, the administrator 112 could access the server 104 to address the problem.

Through its real-time monitoring and logging, the system 100 is able to correlate system, network and security events across multiple feeds of information. Furthermore, the real-time monitoring and logging of the system 100 is readily integrated with existing legacy security applications (e.g., intrusion detection systems, firewalls, remote access solutions) to form a simple, unified platform for the company to detect and respond to all security issues within the enterprise computer system (including the resources 106). Accordingly, the cost and complexity associated with managing multiple, separate security systems, with only the hope of identifying or correlating security or network-based events, are avoided.

Further still, the system 100 readily supports complex forensic analysis since all of the monitored activities and events (i.e., the logged data) are maintained within the system 100. The system 100 can generate detailed reports based on the logged data to facilitate the forensic analysis. As the logged data is periodically archived (e.g., backed up to tape), the logged data can be maintained indefinitely.

Thus, the system 100 allows the company to restrict, track and manage access to critical confidential and private information, as well as provide required audit reporting to be in compliance with a host of privacy legislation (e.g., the Sarbanes Oxley Act, the Health Insurance Portability and Accountability Act (HIPAA), the Gramm-Leach-Bliley Act). Accordingly, the system 100 assists the company in avoiding the potential fines and criminal punishment (as well as the bad press) that can result from non-compliance.

The administrator 112 manages various aspects of the system 100. For example, as noted above, the administrator 112 can register individuals (e.g., the user 102) with the server 104 as authorized users. This can include assigning the user 102 a token (e.g., the memory stick 108) and creating (including any subsequent modifications to) the user profile 126 of the user 102. When creating or modifying the user profile 126, the administrator 112 can define any limits on the access of the user 102. The administrator 112 can also register devices (e.g., the laptop computer 110) as authorized devices for accessing the resources 106. The administrator 112 can perform other tasks relating to the management of the system 100, such as assisting a user that forgets his or her password and scheduling backups of the log 130 from the database 128 to a tape device (not shown).

In one exemplary embodiment, a web-based interface allows the administrator 112 to connect to the server 104 over the network 120 using a standard web browser. In this manner, the administrator 112 can use a device 132 (running the web browser) to connect to the server 104 (e.g., via the network 120) to perform administrative functions. Furthermore, the administrator 112 can use the device 132 to access real-time monitoring of the system 100, as well as to access the log 130 (and/or other logs), reports and system statistics. The device 132 can be a computer, a personal digital assistant (PDA), or any other processing device having input and output (I/O) support. In one exemplary embodiment, the device 132 is a laptop computer. Additionally, alarms, events or the like detected by the server 104 can result in notifications being sent (e.g., via e-mail, text message, phone message) to the administrator and/or recorded in the log 130.

The system 100 is readily scalable. For example, by replacing or modifying the number or type of servers (e.g., the server 104), the system 100 can support an increased number of users (e.g., the user 102) including the associated tokens and devices. As a result, the number or type of other components (e.g., the database 128) of the system 100 could also change.

Unlike conventional systems, the system 100 is readily expandable and customizable. For example, modules 134 can be added to the server 104 to provide increased functionality. The modules 134 can be stored in the database 128 or elsewhere for access by the server 104 as needed. A module is software that performs a single function or task within the context of the system 100. In one exemplary embodiment, the modules 134 are based on a plug-in architecture that provides standard deliverables and customizations through a non-proprietary application program interface (API). The modules 134 can perform functions such as validating prerequisites of the user 102 or the laptop computer 110 (e.g., presence of antivirus software, OS service level). Other exemplary functions of the modules 134 include process monitoring, drive inventory, keystroke logging, VPN launching and application launching.

While each of the modules 134 is generally limited to a single function or task, a module can load a fully functional application. In this manner, the modules 134 can be used to customize the system 100, for example, to load specific applications of the a customer (e.g., the company). The API, which can be accessed via a software developers kit (SDK) provided to the company, allows the company (e.g., employees or contractors of the company) to create customized modules. Additionally, the company can obtain modules created by others. Thus, for example, the company could create and/or obtain a series of modules 134 that support's the company's business. If the company is a bank, one of the modules 134 could be used to launch an application specifically designed to handle transactions involving the bank and its customers, while other modules 134 provide the MFA, access control and monitoring of users (e.g., the user 102) within the system 100.

In view of the above, all users (e.g., the user 102), such as an employee (e.g., an information technology (IT) manager) of the company, must be authenticated and managed by the server 104 in order to obtain access to the resources 106. Additionally, the system 100 is well suited for an environment where non-employees, such as contractors, agents, partners and the like need access to the resources 106 of the company. The MFA of the system 100 makes it hard for the identity of the employee or non-employee to be misappropriated and used to gain access to the resources 106. Furthermore, the strong access control component of the system 100 prevents the employee or non-employee from accessing those resources 106 he or she is not authorized to access. Further still, the in-depth monitoring and logging component of the system 100 supports future correlation and/or forensic analysis of the user's activities. Thus, the system 100 reduces the risks associated with data theft, viral outbreaks or other malicious or non-malicious activities (whether from an internal source or an external source) that can compromise the company's security and/or reputation.

Other aspects of the system 100 are not directly related to authentication, access control or monitoring. For example, in one exemplary embodiment, the system 100 maintains human resource (HR) data on non-employees such as contractors. This HR data can be maintained in the database 128 or in some other data store. The HR data can include a photo ID, a resume, etc. Thereafter, prospective employers can access the HR data (e.g., via a website) to be presented with a list of highly qualified and tightly screened candidates for potentially being granted access to their critical resources.

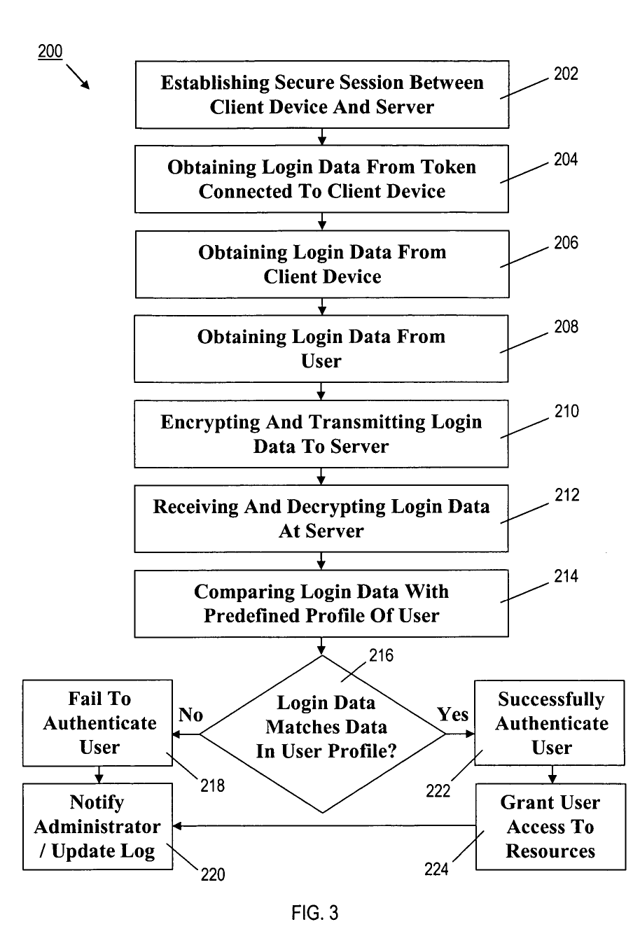

An exemplary method 200 for authenticating the user 102 using MFA will be described with reference to FIGS. 1 and 3. According to the method 200, a secure session is established between a client device (e.g., the laptop computer 110) and the server 104 in Step 202. As noted above, the secure session can be a PKI, RSA-encrypted session or some other form of secure session.

After the secure session is established, a portion of the login data 122 is obtained from a token connected to the client device in Step 204. For example, the serial number of the memory stick 108 connected to the laptop computer 110 is automatically extracted as a component of the login data 122. Another portion of the login data 122 is obtained from the client device itself in Step 206. For example, as noted above, one or more unique and static attributes of the laptop computer 110 are used to created a UDI. The UDI generated from the attributes of the laptop computer 110 forms a portion of the login data 122. Further still, a portion of the login data 122 is obtained directly from the user 102 in Step 208. For example, the user 102 is required to provide information such as a user name, password, etc., which forms a portion of the login data 122.

After the login data 122 is complete, the login data is encrypted and transmitted to the server 104, for example, over the network 120 which is performed in Step 210. Upon receipt of the encrypted login data 122, the server 104 decrypts the login data 122 in Step 212.

The login data 122 is then compared with a predefined profile of the user 102 in Step 214. For example, the login data 122 is compared to the authentication data 124 stored in the user profile 126 of the user 102. In one exemplary embodiment, the server 104 determines if the login data 122 matches the user profile 126 (i.e., the authentication data 124), which occurs in Step 216. In another exemplary embodiment, the server 104 determines if the login data 122 falls within a threshold of the authentication data 124. The administrator 112 can define the threshold.

If the login data 122 does not match (or does not fall within the threshold of) the authentication data 124, the user 102 is not authenticated. This occurs in Step 218. Accordingly, the administrator 112 is notified of the failure to authenticate the user 102 and/or the failure to authenticate the user 102 is recorded in the log 130, which happens in Step 220.

Conversely, if the login data 122 does match (or does fall within the threshold of) the authentication data 124, the user 102 is authenticated in Step 222. Thereafter, server 104 can grant the user 102 access to the resources 106 of the company as described in Step 224. Accordingly, the administrator 112 is notified of the successful authentication of the user 102 and/or the successful authentication of the user 102 is recorded in the log 130. See Step 220.

After the user 102 is authenticated by the exemplary method 200, the server 104 can determine the appropriate level of access control for the user 102, as described above. Furthermore, the server 104 begins monitoring and logging the activities of the user 102 for the duration of the session.

In one exemplary embodiment, the method 200 is implemented as software running on the server 104. Additionally, the method 200 can be implemented from computer instructions stored on a computer readable medium (e.g., an optical disk).

The above description of specific embodiments has been given by way of example. From the disclosure given, those skilled in the art will not only understand the general inventive concept and its attendant advantages, but will also find apparent various changes and modifications to the structures and methods disclosed. It is sought, therefore, to cover all such changes and modifications as fall within the spirit and scope of the general inventive concept, as defined in the claims, and equivalents thereof. Thus, the embodiments described in the specification are only exemplary or preferred and are not intended to limit the terms of the claims in any way. The terms in the claims have all of their broad ordinary meanings and are not limited in any way or by any descriptions of these exemplary embodiments.

It is claimed:

1. A system for authenticating a user using a client device to request a resource, the system comprising:
a server; and
a token,
wherein the token is connected to the client device;
wherein the server receives first login data extracted from the token;
wherein the server receives second login data generated from a plurality of attributes of the client device;
wherein the server receives third login data input by the user;
wherein the server compares the first login data with first authentication data which defines an authorized token associated with an authorized user;
wherein the server compares the second login data with second authentication data which defines an authorized client device associated with the authorized user;
wherein the server compares the third login data with third authentication data associated with the authorized user; and
wherein if the first login data, the second login data and the third login data match the first authentication data, the second authentication data and the third authentication data, respectively, the server determines the user is the authorized user.

2. The system of claim 1, wherein the token is a portable flash memory device.

3. The system of claim 1, wherein the token interfaces with a universal serial bus port of the client device.

4. The system of claim 1, wherein the second login data is generated from at least twenty attributes of the client device.

5. The system of claim 1, wherein the third login data is an alphanumeric password.

6. The system of claim 1, wherein if the server determines the user is the authorized user, the server grants the user access to the resource.

7. The system of claim 6, wherein the server limits the access of the user to the resource based on a predetermined user profile.

8. The system of claim 1, wherein the client device and the server are in communication over a network.

9. The system of claim 8, wherein the network is the Internet.

10. The system of claim 8, where a secure session is established between the client device and the server over the network.

11. The system of claim 10, wherein all activity of the user is recorded by the server during the session.

12. An apparatus for authenticating a user using a client device to request a resource, the apparatus comprising:
a processor; and
a network interface,
wherein first login data extracted from a token connected to the client device is received via the network interface;
wherein second login data generated from a plurality of attributes of the client device is received via the network interface;
wherein third login data input by the user is received via the network interface;
wherein the processor compares the first login data with first authentication data which defines an authorized token associated with an authorized user;
wherein the processor compares the second login data with second authentication data which defines an authorized client device associated with the authorized user;
wherein the processor compares the third login data with third authentication data associated with the authorized user; and
wherein if the first login data, the second login data and the third login data match the first authentication data, the second authentication data and the third authentication data, respectively, the processor determines the user is the authorized user.

13. The apparatus of claim 12, wherein the second login data is generated from at least twenty attributes of the client device.

14. The apparatus of claim 12, wherein the third login data is an alphanumeric password.

15. The apparatus of claim 12, wherein if the processor determines the user is the authorized user, the user is granted access to the resource.

16. The apparatus of claim 15, wherein the apparatus limits the access of the user to resource based on a predetermined user profile.

17. The apparatus of claim 15, wherein the apparatus records all activity of the user during a session established between the apparatus and the client device.

18. A method of authenticating a user using a client device to request a resource, the method comprising:
extracting first login data from a token connected to the client device;
generating second login data from a plurality of attributes of the client device;
obtaining third login data from the user;
comparing the first login data with first authentication data which defines an authorized token associated with an authorized user;
comparing the second login data with second authentication data which defines an authorized client device associated with the authorized user;
comparing the third login data with third authentication data associated with the authorized user; and
wherein if the first login data, the second login data and the third login data match the first authentication data, the second authentication data and the third authentication data, respectively, determining the user is the authorized user.

19. The method of claim 18, further comprising recording the activity of the user.

20. The method of claim 18, further comprising if the user is determined to be the authorized user, granting the user access to the resource.

21. The method of claim 20, further comprising limiting the access of the user to the resource.
